(19) United States
(12) Patent Application Publication
(10) Pub. No.: US 2015/0060185 A1
(43) Pub. Date: Mar. 5, 2015

(54) Steering System Applied to Motor Vehicles

(71) Applicant: Chafic Samir FEGURI, CUIABA (BR)

(72) Inventor: Chafic Samir FEGURI, CUIABA (BR)

(21) Appl. No.: 14/467,014

(22) Filed: Aug. 24, 2014

(30) Foreign Application Priority Data
Aug. 28, 2013 (BR) BR1020130219150

(51) Int. Cl. B60W 30/18; B60K 26/02; B62D 1/12; B60K 37/06; B62D 5/00; B60T 7/08

(52) U.S. Cl. CPC B60W 30/18181; B62D 5/003; B60T 7/08; B62D 1/12; B60K 37/06; B60K 26/02
USPC 180/333

(57) ABSTRACT

A steering system applied to motor vehicles comprising a body (10) arranged on the dashboard (200) of the vehicle, wherein the internal portion of the body (10) has a guide rail (1121) that guides the upward and downward movement of a trigger (112) pushed by a counter spring (1122) when the driver pushes or pulls the control portion (101) of the steering wheel (100) for braking or accelerating, respectively, wherein a first electronic sensor (401) is arranged on the upper portion of said trigger (112), and a second electronic sensor (402) is arranged on the upper portion of the guide rail (1121), wherein said sensors (401) and (402) are interconnected with the acceleration system of the vehicle, and a steering wheel (100) arranged in the internal portion of the body (10), wherein said steering wheel (100) has a bearing in the lower portion of an axle (111) which is interconnected with the steering shaft (300) or an electronic control unit (500), and has a control portion (101) arranged on the front and a pressing area on the rear in order to move a trigger (112) of the accelerator.

### CROSS-REFERENCE TO RELATED APPLICATIONS

This Application is a CONTINUATION application claiming the benefit of foreign priority of the co-pending Federal Republic of Brazil Application No. BR1020130219150, filed 28 Aug. 2013, the entire disclosures of which is expressly incorporated by reference in its entirety herein.

### FIELD OF THE INVENTION

This invention relates to a steering system applied to motor vehicles. More specifically, this invention relates to an electronic power steering system having a mechanical linkage between the steering wheel and the steering box or an electronic control unit.

### BACKGROUND OF THE INVENTION

The aim of a steering system is to convey the rotational motion of the steering wheel to the wheels and absorb a part of their impact on the ground so that the driver doesn't feel it.

The steering system of motor vehicles, which, at the beginning of the history of the automobile, was similar to that of a bicycle and had a kind of a handlebar for a driver to steer it, nowadays comes equipped with the hydraulic power steering that uses hydraulic pressure to make an effort instead of a driver and steer the vehicle, making use of a hydraulic pump which is operated by the engine of the vehicle and keeps oil under pressure.

In the electric hydraulic power steering system, the hydraulic pump is operated by an electric engine, which, in its turn, is controlled by the electronic control unit of the vehicle. Thus, the module can control the entire operation of the pump and, as a result, the pressure of the system and its action on the steering box which has sensors so that the electronic control unit can monitor its movements and make better decisions.

Therefore, power-assisted steering systems are evolving and incorporating technologies that ensure safety and lower costs that allow them to be adapted to conventional vehicles.

However, whichever the case might be, it is necessary to use both hands on the wheel and the right foot to actuate the accelerator or the brakes. In addition, vehicles need at least three mechanical components arranged in different places of the vehicle —steering wheel, accelerator and brake pedals.

In an effort to make driving easier, the car industry has recently launched a steering system having a steering wheel that moves a kind of potentiometer, which, in its turn, informs the electronic control unit that tells one or more electric engines to turn the wheels to the side chosen by the driver, there being no steering column. Said system called drive-by-wire is totally electronic, the steering wheel sometimes being a joystick which is mounted in the center of the dashboard of a vehicle where the gear shift lever usually is. In said system, all the control of the vehicle is on this joystick where the accelerator is actuated when the joystick is pulled back on. The brakes are actuated when the joystick is pushed forward. When the joystick is pushed to the left or to the right, an electric engine is actuated, turning the wheels of the vehicle to the right or to the left. Nevertheless, high implementation costs hinder its generalized application to vehicles as well as it is affected in the event of an electric failure.

Nevertheless, in case of an electric failure, the steering system stops working as there is no steering column that allows a mechanical linkage. On the other hand, actuating the accelerator and actuating the brakes sometimes confuse the driver as he or she tends intuitively to push the joystick forward to accelerate the vehicle and pull back on it to brake the vehicle, which are movements contrary to those of the drive-by-wire system. In case of emergency braking, the abrupt movement of the joystick tends to throw the driver's body forward, running the serious risk of throwing his or her hand forward and starting inadvertently the acceleration process.

Therefore, there is need for a steering system applied to vehicles, which has the steering wheel with all controls arranged on it, thus eliminating the need for a clutch pedal, an acceleration pedal and a brake pedal, said steering wheel being interconnected with the steering column of the vehicle or an electronic control unit.

### SUMMARY

There is provided a steering system adapted to vehicles having an automatic transmission, a semi-automatic transmission or a continuous shift system such as CVC (continuously variable transmission).

There is provided a steering system that allows both front seat occupants to steer a vehicle by using one of their hands with total comfort and safety.

There is provided a steering system that uses an original steering shaft of the vehicle to make the wheels turn or in an electronic manner by using the drive-by-wire system.

### BRIEF DESCRIPTION OF THE FIGURES

The FIG. 1 shows the position of the steering wheel on the dashboard of the vehicle.

FIG. 2 is a frontal view of the steering wheel fitted into the fixed body.

FIG. 3 is a view from above, showing the steering wheel having the controls on the front, stops, and a guide rail for upward and downward movement in the fixed body.

FIG. 3A is a side view of the steering wheel pushed for braking, showing the actuation of a trigger, and FIG. 3B is a view from above of the same motion.

FIG. 4A is a side view of the steering wheel pushed for braking while keeping the trigger pressed, and FIG. 4B is a view from above of the same motion.

FIG. 5A shows a steering wheel not shifted downward with relation to the body, with the sensor (402) arranged at the beginning of the acceleration area, providing slow acceleration, and FIG. 5B is a view from above of the same motion.

FIG. 6A shows a vehicle under maximum acceleration when the sensors (402) and (401) are positioned adjacently and FIG. 6B is a view from above of the same motion.

FIG. 7 shows a steering wheel attached to the steering shaft of the vehicle and to the original braking system.

FIG. 8 shows the details of a rack arranged on the moving part of the steering wheel attached to the steering shaft.

FIG. 9 shows a steering wheel and a representation of the rotation of up to 170 degrees in order to turn the wheels, and FIG. 9A shows the fixed body.

FIG. 10 shows a steering wheel adapted to vehicles with electronic power steering and without a steering column.

FIG. 11A is a cross-sectional view of the steering wheel attached to an electronic power steering system and FIG. 11B shows the shifting of the moving part of the steering wheel for braking by using the electronic system.

FIG. 12A shows the braking system attached to a vehicle with a steering shaft and FIG. 12B shows the braking system attached to a vehicle with electronic power steering.

FIG. 13A shows the mechanical braking system applied to a vehicle with a steering shaft, illustrating the non-actuated trigger and FIG. 13B shows the mechanical braking system applied to a vehicle with electronic power steering, illustrating the non-actuated trigger.

FIG. 14A shows the mechanical braking system applied to a vehicle having a steering shaft, illustrating the actuated brakes and the non-actuated trigger moving away from the shaft that pulls the accelerator cable, thus preventing the acceleration; and FIG. 14B shows the mechanical braking system applied to a vehicle having electronic power steering, illustrating the actuated brakes and the non-actuated trigger moving away from the shaft that pulls the accelerator cable, thus preventing the a acceleration.

FIG. 15A shows the mechanical braking system applied to a vehicle having a steering shaft, illustrating the shaft pulling the accelerator cable, and FIG. 15B shows the mechanical braking system applied to a vehicle having electronic power steering, illustrating the bar pulling the accelerator cable.

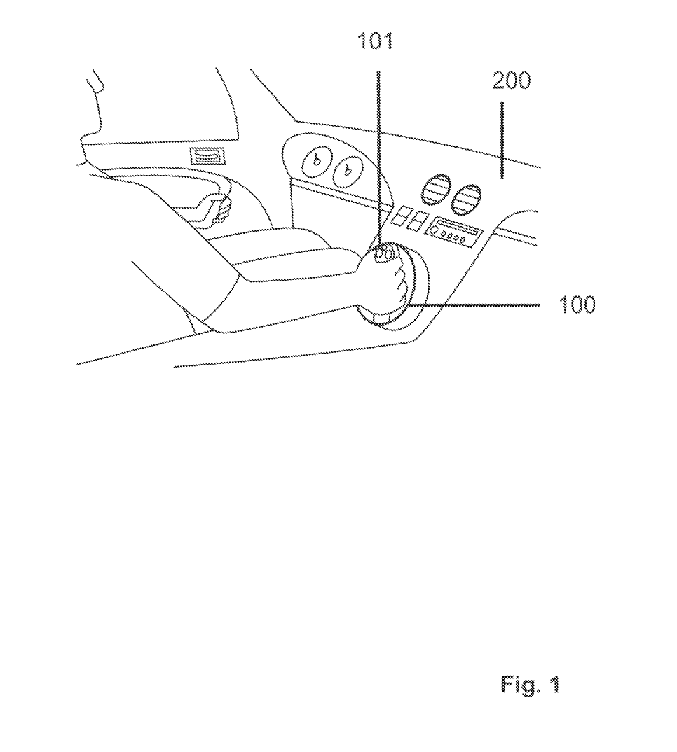

### DETAILED DESCRIPTION OF THE INVENTION

The steering system applied to vehicles, subject matter of this invention, comprises a body (10) arranged on the dashboard (200) of the vehicle, preferably, in the central portion, between the two front seat occupants of the vehicle, allowing both of them to steer the vehicle.

A steering wheel (100) having a bearing in the lower portion of an axle (111) interconnected with the steering shaft (300) of the vehicle or an electronic control unit (400) is arranged in the central portion of the body (10), said steering wheel rotating and moving upward and downward for acceleration and breaking, respectively.

The front of the wheel (100) has a control portion (101) on which the controls for driving the vehicle such as acceleration, steering, braking, gear shift, honk, and turn signals are arranged, allowing them to be actuated by only one of the driver's hands to ensure driveability of the vehicle, and a pressing portion to provide movement of a trigger (112) of the accelerator on the rear.

A guide rail (1121) is arranged on the inner surface of the body (10), which guides the upward and downward movement of the trigger (112) when the driver pushes or pulls the controlling portion (101) of the steering wheel (100) to brake or accelerate, respectively.

A first electronic sensor is arranged on the upper portion of the trigger (112) and a second electronic sensor (402) is arranged on the upper portion of the guide rail (1121), said sensors (401) e (402) being interconnected with the acceleration system of the vehicle.

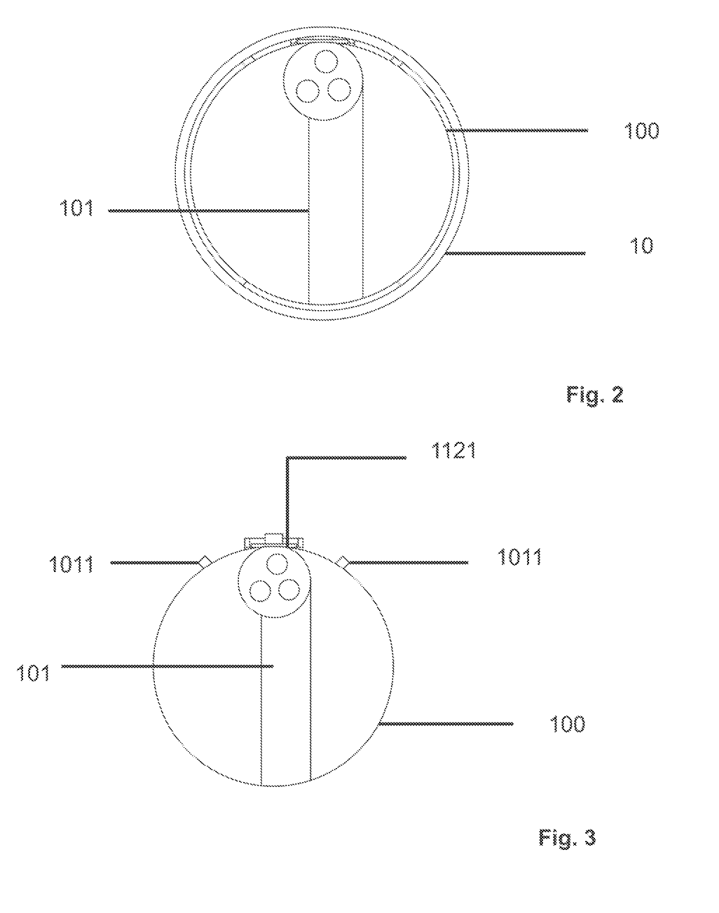

After being pushed by the user for braking, the control portion (101) of the steering wheel (100) moves the trigger (112) on the guide rail (1121), said trigger (112) being pushed by a counter spring (1122) as shown in the FIGS. 3A and 3B, in order to keep the sensor (401) aligned with the upper edge of the body (10). In this situation, the sensor (402) moves away from the sensor (401), stopping acceleration.

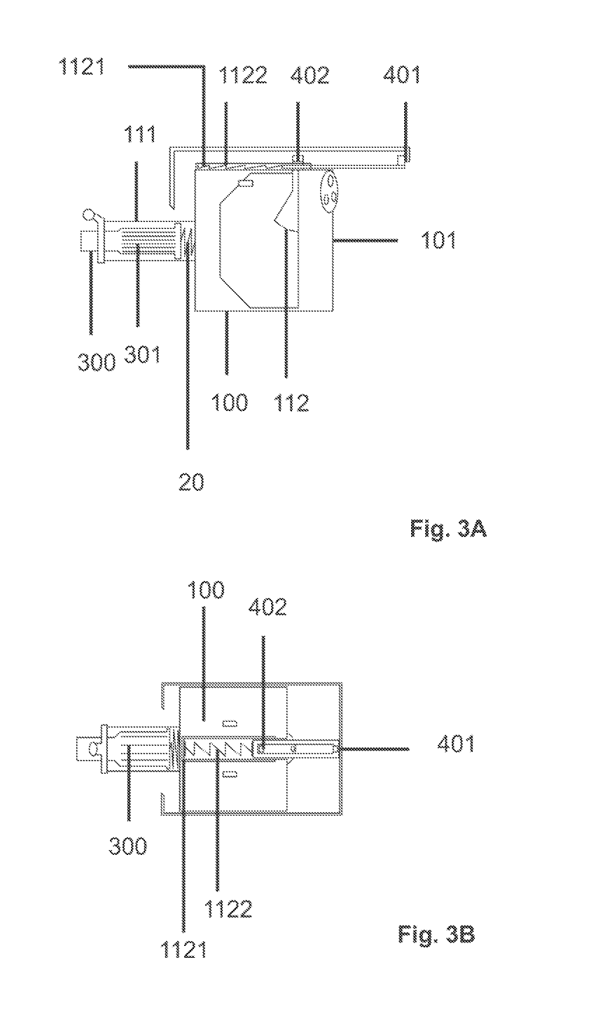

As shown in FIGS. 4A and 4B, the acceleration trigger (112) is pressed, but the sensor (402) is away from the sensor (401), there no being contact for acceleration. Thus, the counter spring (1122) keeps the sensor (401) away from the sensor (402) during braking. Even though the driver keeps pressing the acceleration trigger (112) while moving the steering wheel (100) downward with relation to the body (10) in a movement typical of braking, the distance between the sensors (401) and (402) disables the acceleration.

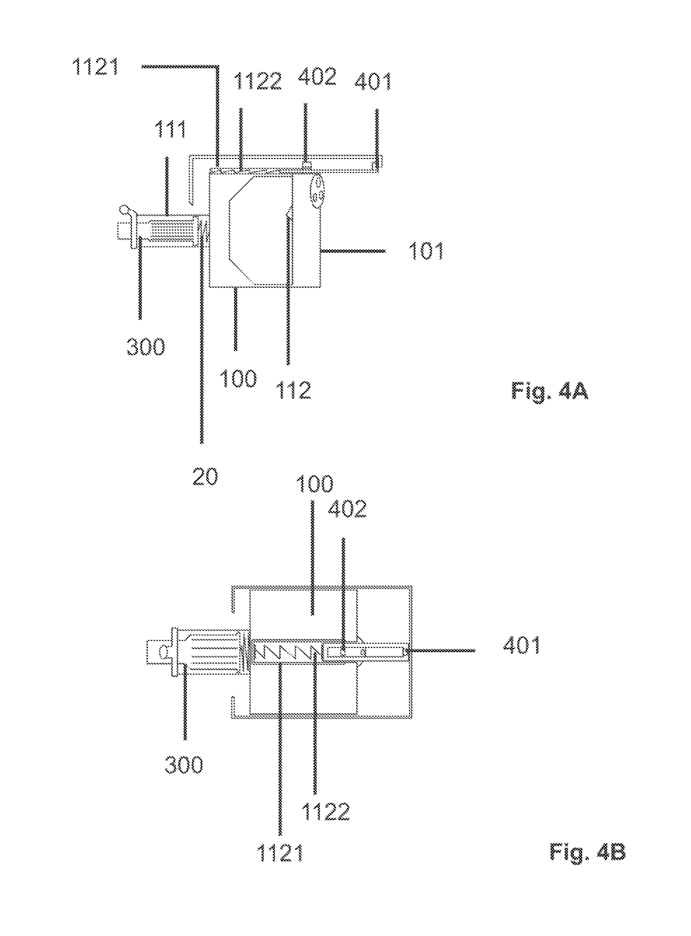

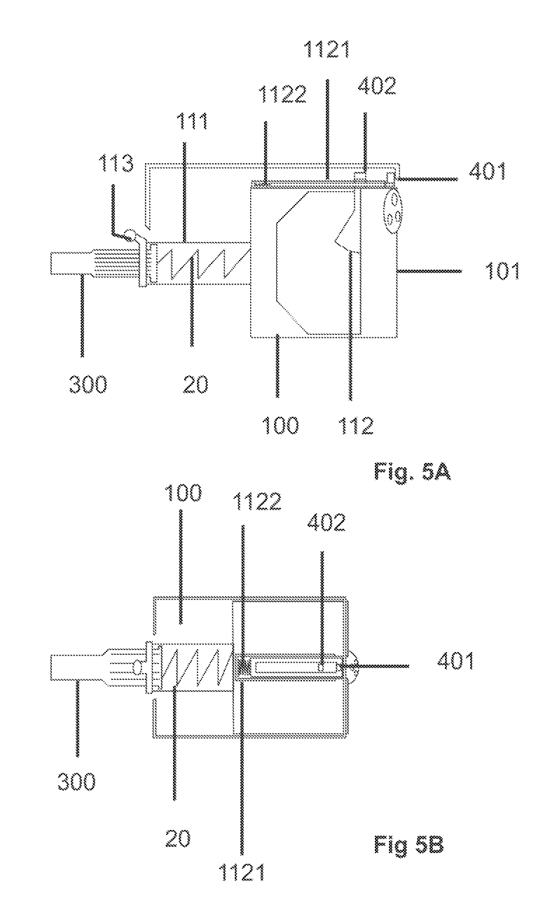

As shown in FIG. 5A, the steering wheel (100) has not been moved downward with relation to the body (10), therefore the brakes are not actuated. In this situation it is possible to see that the sensor (402) is at the beginning of the acceleration space providing slow acceleration which increases as the driver keeps pressing the trigger (112) in order to bring the sensors (402) and (401) closer to each other, thus obtaining maximum acceleration as shown in FIGS. 6A and 6B.

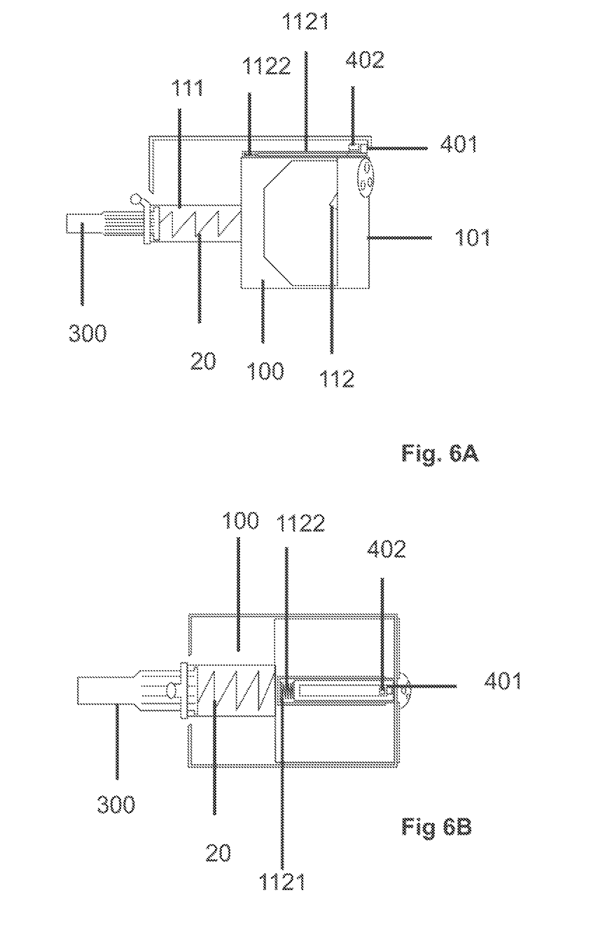

To brake the vehicle, the driver stops pressing the trigger (112) of the steering wheel (100) and pushes the steering wheel (100) down toward the base of the body (10) by stretching a spring (20) arranged between the base of the steering wheel (100) and said body (10), thus acting on a component having an internal bearing (113) interconnected with the braking system of the vehicle (400) as shown in FIG. 7. After the user stops exerting pressure on the wheel (100), the spring (20) moves said steering wheel (100) back to the initial position, thus stopping braking.

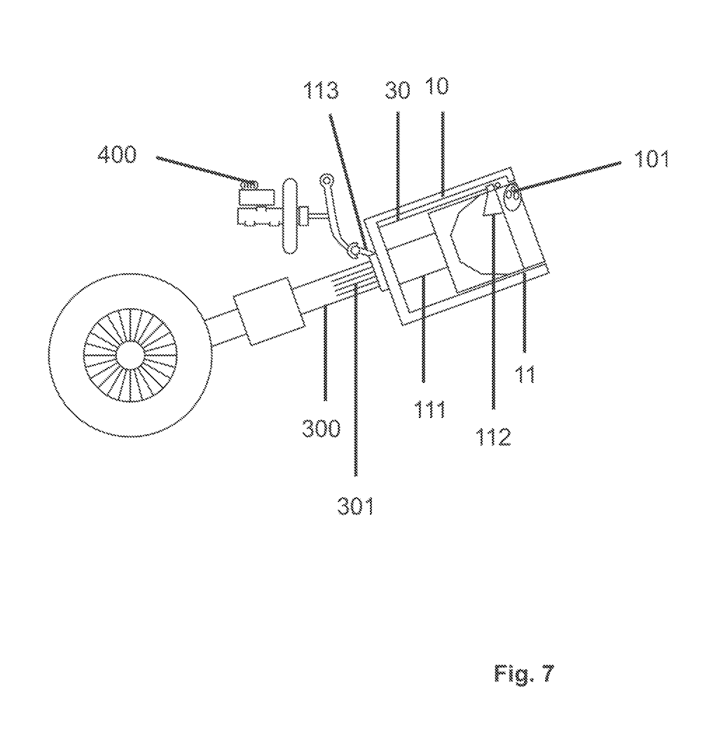

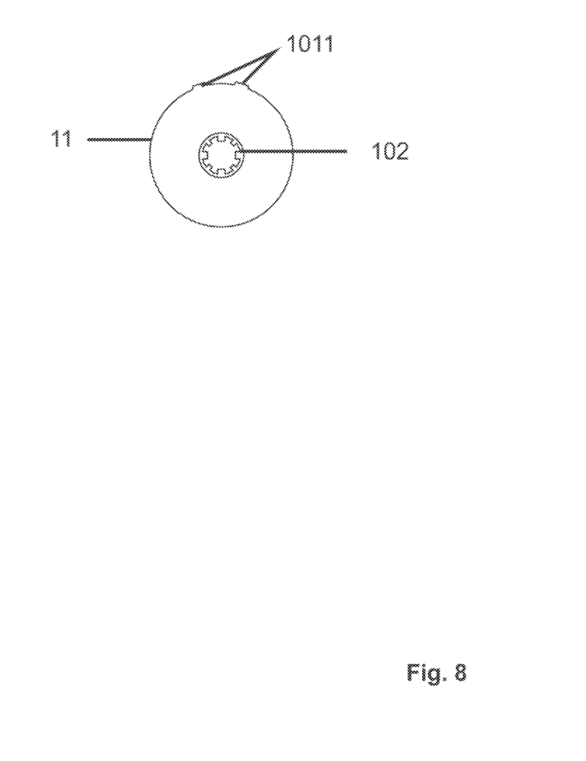

A guide or a guide rail (301) is arranged on the steering column (300) so that a rack (102) arranged on the moving component (11), as shown in FIG. 8, engages the steering column (300) whenever the steering wheel (100) is rotated together with the steering shaft (300), and, as a result, turns the wheels of the vehicle as shown in FIG. 9.

To move the vehicle to the right or to the left, the steering wheel (100) is rotated to the respective side, the maximum rotation being 170 degrees to both sides enough to provide the full turn of the wheel as shown in FIG. 9. When the control portion (101) is fully turned, a stop (1011) arranged in the outermost part of the control portion (101) interferes with the stop (105) arranged on the surface of the body (10), thus limiting the full turn of the control portion (101).

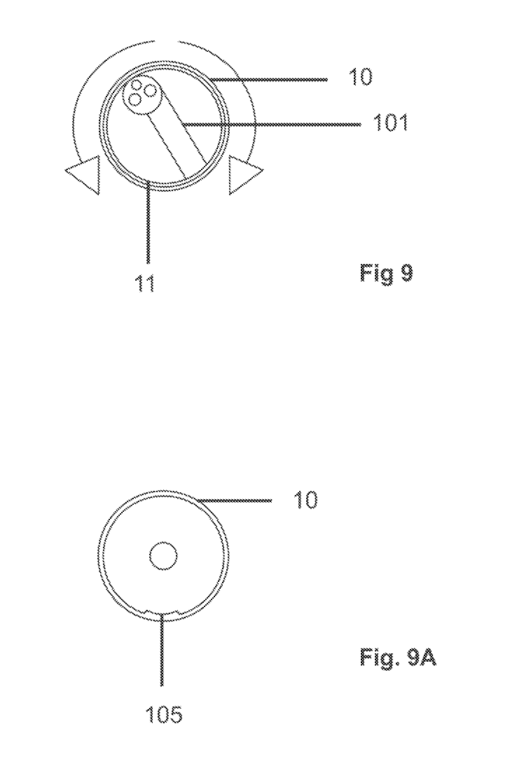

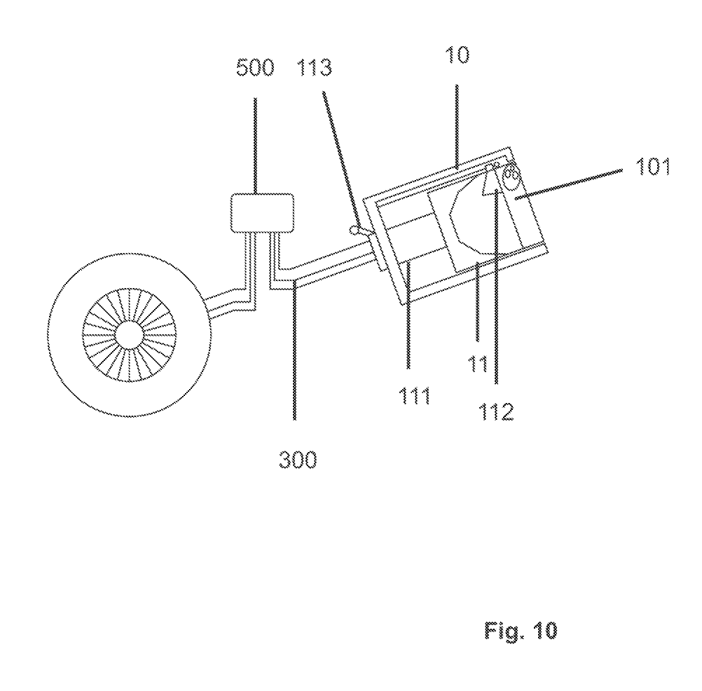

The steering system may be adapted to vehicles having electronic power steering without a steering column as shown in FIG. 10 so that the axle (111) of the steering wheel is connected to an electronic control unit (500), the wheels being turned by electric engines.

A trigger (112) is provided on the control portion (101), which, after being pressed, moves on a guide rail (1121) having a counter spring (1122), thus providing acceleration of the vehicle by actuating the accelerator cable (30) as shown in FIG. 8C.

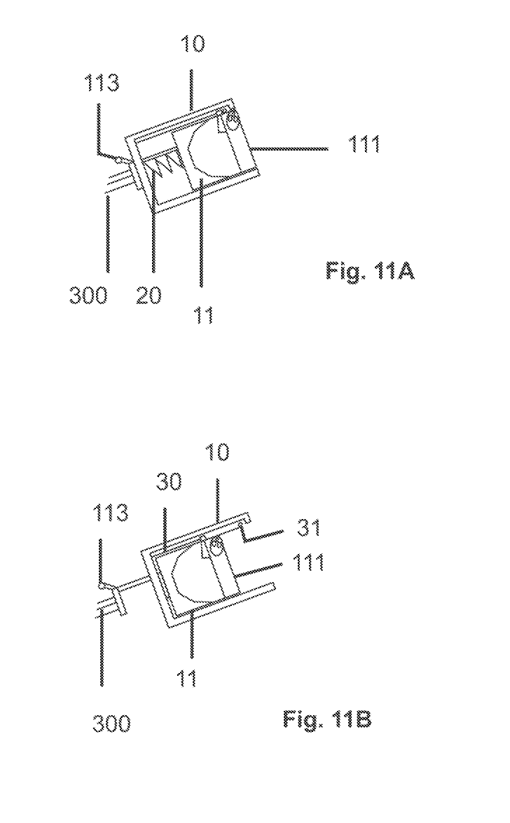

Alternatively, in vehicles having a steering shaft (300) and electronic power steering (400), as shown in FIGS. 12A and 12B, respectively, there is provided a fixed shaft (50) interconnected with the accelerator cable (30) of the vehicle and aligned with the trigger (112) in the acceleration position.

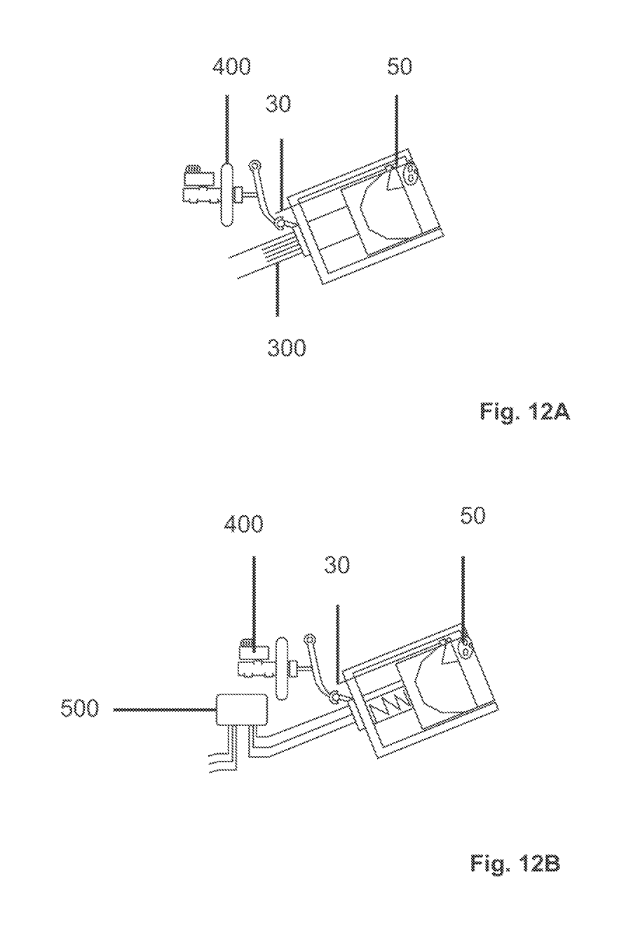

When the trigger (112) is pressed by the driver, it pushes the shaft (50) that pulls the accelerator cable (30), thus accelerating the vehicle, as shown in FIGS. 13A and 13B.

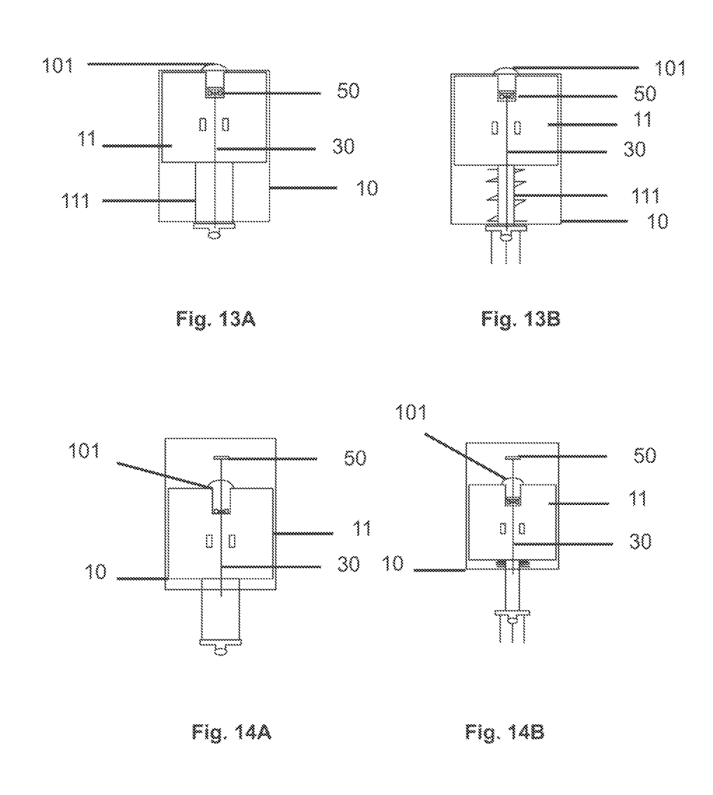

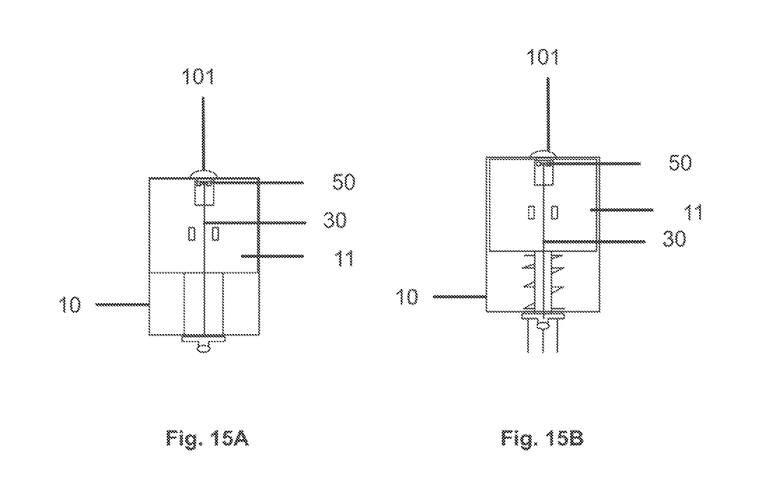

When the moving component (11) is moved downward in the body (10), the trigger (112) moves away from the shaft (50), slowing down and braking the vehicle, as shown in FIGS. 14A and 14B. Thus, even though the driver brakes and accelerates the vehicle at the same time, the trigger (112) and the shaft (50) interconnected with the accelerator cable (30) are away from each other, the acceleration being annulled and the functioning of the brakes prioritized.

What is claimed is:

1. Steering system applied to motor vehicles comprising:
a) a body (10) arranged on the dashboard (200) of the vehicle, the internal portion of the body (10) having a guide rail (1121) that guides the upward and downward motion of a trigger (112) pushed by a counter spring (1122) when the driver pushes or pulls the control portion (101) of the steering wheel (100) to brake or accelerate, respectively, wherein a first electronic sensor (401) is arranged on the upper portion of said trigger (112) and a second electronic sensor (402) is arranged on the upper portion of the guide (1121), wherein said sensors (401) and (402) are interconnected with the acceleration system of the vehicle;
b) a steering wheel (100) arranged in the inner portion of the body (10), wherein said steering wheel (100) has a bearing in the lower portion of the axle (111) interconnected with the steering shaft (300), wherein said steering wheel (100) has a control portion (101) arranged on the front and a pressing portion arranged on the rear to move a trigger (112) of the accelerator, wherein said steering wheel has a spring (20) arranged between the base and the body (10), which acts on a component with internal bearing (113) interconnected with the braking system of the vehicle (400);
c) a steering shaft (300) having a guide (301) that engages a rack (102) arranged on the moving component (11) into the steering column (300) whenever the steering wheel (100) is turned together with the steering shaft (300).

2. Steering system applied to motor vehicles comprising:
a) A body (10) arranged on the dashboard (200) of the vehicle, the internal portion of the body (10) having a guide rail (1121) that guides the upward and downward movement of a trigger (112) pushed by a counter spring (1122) when the driver pushes or pulls the control portion (101) of the steering wheel (100) to brake or accelerate, respectively, wherein a first electronic sensor (401) is arranged on the upper portion of said trigger (112) and a second electronic sensor (402) is arranged on the upper portion of the guide rail (1121), wherein said sensors (401) and (402) are interconnected with the acceleration system of the vehicle;
b) a steering wheel (100) arranged in the inner portion of the body (10), wherein said steering wheel (100) has a bearing in the lower portion of the axle (111) interconnected with the electronic control unit (400), wherein said steering wheel (100) has a control portion (101) arranged on the front and a pressing portion arranged on the rear to move a trigger (112) of the accelerator, wherein said steering wheel has a spring (20) arranged between the base and the body (10), which acts on a component with internal bearing (113) interconnected with the braking system of the vehicle (400);

3. Steering system applied to motor vehicles as in claims 1 and 2 wherein sensors (401) and (402) are moved away from each other and stop acceleration, wherein said sensors (401) and (402) are moved away from each other when the user pushes the control portion (101) of the steering wheel (100) for braking, thus moving the trigger (11) on the guide rail (1121), wherein said trigger (112) is pushed by the counter spring (1122), keeping the sensor (401) aligned with the upper edge of the body (10).

4. Steering system applied to motor vehicles as in claims 1 and 2 wherein there is provided a stop (1011) in the outermost portion of the body (10) in order to limit the full turn of the control portion (101).

5. Steering system applied to motor vehicles as in claims 1 and 2 wherein, alternatively, there is provided a fixed shaft (50) interconnected with the accelerator cable (30) of the vehicle and aligned with the trigger (112) in the acceleration position, wherein said trigger (112), after being pushed by the driver, pushes the shaft (50) that pulls the accelerator cable (30), thus providing acceleration of the vehicle.
